(19) United States
(12) Patent Application Publication
(10) Pub. No.: US 2017/0174042 A1
(43) Pub. Date: Jun. 22, 2017

(54) BOTTLE ACTUATOR APPARATUS AND SYSTEM

(71) Applicant: Pacific Link LLC, Richardson, TX (US)

(72) Inventors: Alexander Kuo, Dallas, TX (US); James H. Monti, JR., Plano, TX (US)

(21) Appl. No.: 14/680,066

(22) Filed: Apr. 7, 2015

(51) Int. Cl. B60H 1/00

(52) U.S. Cl. CPC B60H 1/00585

(57) ABSTRACT

An apparatus and system for refilling or servicing a device, such as an automobile coolant system, with pressurized contents are disclosed. In one embodiment, the apparatus includes an actuator pin adapted to control flow and is capable of operating with either a puncture top bottle or internal valve bottle containing pressurized contents are disclosed. The apparatus includes means to prevent flow and secure the pressurized contents once the puncture top bottle or internal valve bottle containing pressurized contents is actuated.

### BACKGROUND

The apparatus and system disclosed herein relates to a bottle actuator assembly designed to operate in conjunction with a pressurized bottle, such as a refrigerant bottle used for re-charging and servicing automobile air conditioning/coolant systems. More specifically, the apparatus and system allows for operation with both a puncture top bottle as well as a bottle with an internal valve. Additionally, the apparatus and system allows a non-professional to easily measure the pressure of the coolant system while re-charging.

Typical coolant systems, such as those found in an automobile air conditioner, include three main components—the compressor, condenser, and evaporator. A compressor is a pump driven by a belt attached to the engine's crankshaft. Refrigerant is drawn into the compressor in a low-pressure gaseous form. Once inside the compressor, a belt drives the pump pressurizing the gas which thereby gets hot by absorbing the surrounding heat.

Conversely, as the pressure of the gas decreases, the gas temperature decreases. This expansion of the refrigerant gas in a coolant system acts to cool the system containing the refrigerant. Air is then blown over the cooled system into the cabin of the automobile.

In such an air conditioning unit, the ability of cooling provided using the compression and expansion of a gaseous refrigerant will vary depending on the level of refrigerant present in the system. For numerous reasons, refrigerant may slowly leak from the air conditioning system. As such, an automobile air conditioning system may require routine monitoring of the refrigerant level or pressure and periodic re-charging the refrigerant.

To allow re-charging of the refrigerant, automotive air conditioners are generally provided with a service port to permit the addition of refrigerant as well as to permit the inspection of the level of refrigerant in the system. Although such re-charging and inspection is typically performed by service professionals, a significant number of automobile owners prefer to perform routine maintenance on their own vehicles, in part due to the savings obtained.

One standard tool used by service professionals for re-charging refrigerant and measuring pressure or other parameters in automobile air conditioners is a set of manifold gauges. This tool typically includes three hoses and two gauges; wherein one hose connects to a low pressure service port; one hose connects to a high pressure service port; and a third hose connects to the source of refrigerant. The gauges are then used to measure the pressure at the service ports. Although manifold gauges may be a standard tool used by service professionals, a number of disadvantages may reduce their popularity among general consumers. These disadvantages include: being complicated to use; requiring the user to know the approximate ambient temperature; requiring a user to look up the pressure readings of the gauges on a chart to determine if there is sufficient refrigerant in the system; presenting a high up-front costs of equipment that is infrequently used.

In recent years, to eliminate the amount of hoses and gauges, products have been developed to provide a single gauge and a single hose such as the examples described in U.S. Pat. No. 6,978,636; and U.S. Pat. No. 7,260,943. However, for those products the actuator assembly is designed to operate only with the pressurized container that the actuator assembly is sold with. Accordingly, there is a need for a new apparatus and system for providing re-charging of refrigerant and measuring the pressure of coolant systems using an adaptable bottle actuator assembly capable of interoperating with various forms of pressurized bottles. Furthermore, there is also a need for replacing traditional measuring gauges which are difficult to use as the user must know the ambient temperature, with gauges that are capable of adapting to the ambient temperature to ensure proper pressure in the coolant system regardless of the outside temperature.

Various apparatus and system embodiments of the present invention may be used that are adaptable to various pressurized bottles, including puncture top bottles and internal valve bottles used to re-charge refrigerant in air conditioners/coolant systems, such as those used in automobiles. Embodiments of the present invention may also allow a consumer to measure the refrigerant pressure in an automobile air conditioner, and to add refrigerant as needed. However, the various apparatus and system embodiments are also adapted to service any system which requires re-charging from a pressurized container and providing a method to measure the pressure of the system to be charged. Additional advantages of embodiments of the invention are set forth, in part, in the description which follows and, in part, will be apparent to one of ordinary skill in the art from the description and/or from the practice of the invention.

### SUMMARY OF THE INVENTION

An apparatus and system for refilling or servicing a device, such as an automobile coolant system, with pressurized contents are disclosed. The invention provides an apparatus for servicing an automobile coolant system adapted to actuate and receive pressurized contents from a puncture top bottle and a bottle having an internal valve. A puncturing tube is adapted to be capable of piercing a puncture top and actuating an internal valve. A means for controlling flow communications between the pressurized contents of the bottle and the automobile coolant system is also provided.

In another aspect, a measuring device is provided to measure parameters of the automobile coolant system, such as pressure.

In another aspect, the measuring device includes an ambient temperature monitor to indicate an optimal pressure in the system with respect to current conditions.

### BRIEF DESCRIPTION OF THE DRAWINGS

FIG. 1 is a perspective view of the bottle actuator assembly device in accordance with the invention.

FIG. 2 is a perspective view of the individual components of the bottle actuator assembly device in accordance with the invention.

FIG. 3 is a top perspective view of a measuring gauge in accordance with the invention

FIG. 4 is a top perspective view of the individual components of a measuring gauge in accordance with the invention.

FIG. 5 is a perspective view of the bottle actuator assembly device in accordance with the invention operating with a puncture top bottle.

FIG. 6 is a perspective view of the bottle actuator assembly device in accordance with the invention operating with a internal valve top bottle.

FIG. 7 is a perspective view of the bottle actuator assembly device in accordance with the invention wherein flow communications between a bottle and a system to be re-charged is open.

FIG. 8 is a perspective view of the bottle actuator assembly device in accordance with the invention wherein flow communications between a bottle and a system to be re-charged is closed.

### DETAILED DESCRIPTION

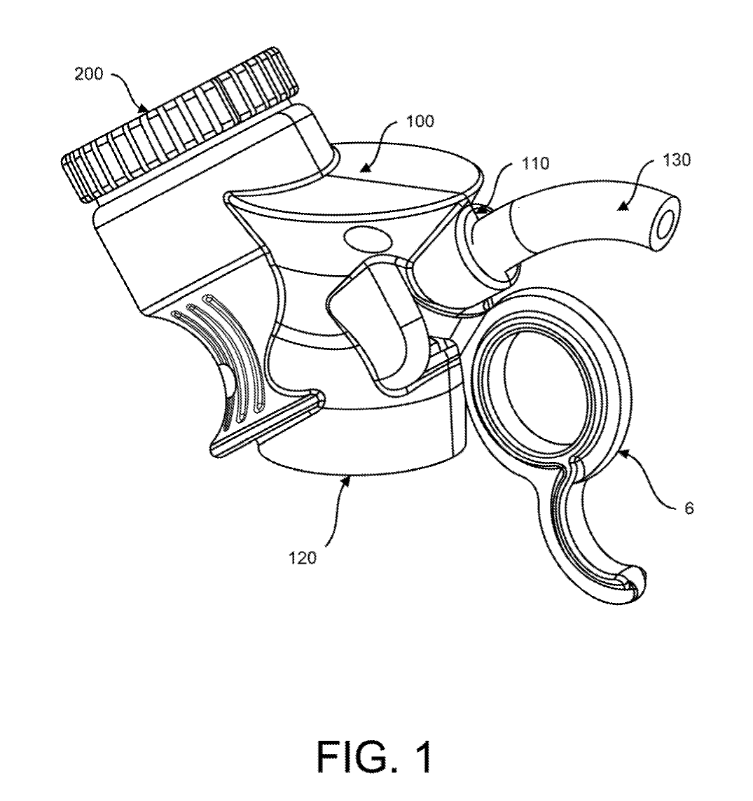

While the inventions disclosed herein are susceptible to various modifications and alternative forms, specific embodiments are shown by way of examples in the drawings and described in detail. It should be understood that the figures and detailed description discussed herein are not intended to limit the invention to the particular forms disclosed. On the contrary, the intention is to cover all modifications, equivalents and alternatives falling within the spirit and scope of the present inventions as defined by the appended claims. Description will now be given of the invention with reference to FIGS. 1-8.

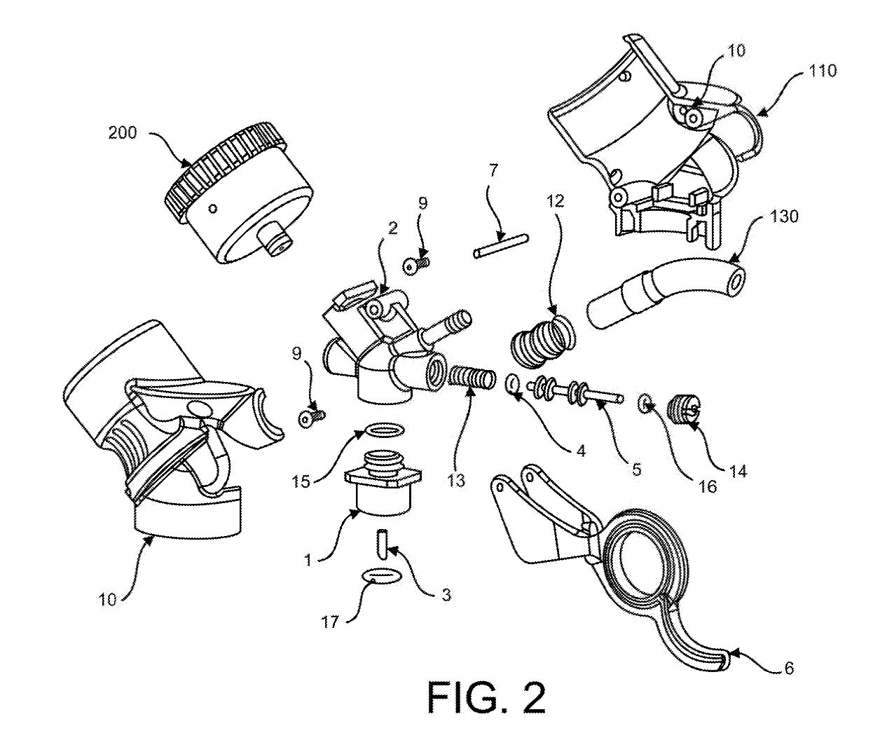

As shown generally in FIGS. 1 and 2, the inventive bottle actuator assembly 100 operable with both internal valve bottles and puncture top bottles preferably includes a number of easily manufactured and assembled components. In an exemplary embodiment, the bottle actuator assembly housing 10 is designed to fit any standard ½″ 16 Acme Thread automotive refrigerant bottle. (The ½″ 16 Acme Thread is a commonly used standard for the U.S. automotive refrigerant market. The thread is utilized due to its unique thread size and measurement so that coolant is not purposely or accidentally dispensed without the correct tooling that fits such thread specifically made for the automotive refrigerant market.) Alternatively, the bottle actuator assembly housing 10 may include and adjustable nozzle thereby allowing the housing 10 to fit other non-standard sized bottles. In an exemplary embodiment, the bottle actuator assembly 100 includes a measuring gauge 200, actuation lever 6, and ports 110 and 120. Additionally, in this exemplary embodiment, a hose 130 connects to port 110 on one end and connects to an automobile coolant system port on the other end via nozzle 140. In the exemplary embodiment, hose 130 is secured to port 110 with the use of a ferrule 12. Port 120 of the bottle actuator assembly 100 attaches around the outer edges of an opening of an automotive refrigerant bottle, or any other compatible pressurized bottle.

As shown in FIG. 2, the exemplary bottle actuator assembly 100 is preferably constructed from a number of easily replicable and interchangeable components. These components include splitter assembly 2, actuator pin 5, O-rings 4, 15, 16, 17, spring 13, set screw 14, dowel pin 7, brass insert 1, pierce tube 3 and actuation lever 6, all assembled within housing 10. Also preferably disposed in housing 10 is measuring gauge 200. Screws 9 may be used to further secure measuring gauge 200 to the housing 10. Measuring gauge 200 has a port connected to splitter assembly 2 to provide flow communications.

In the bottle actuator assembly 100, actuator pin 5, O-rings 4, 16, spring 13 and set screw 14 which are used to seal and control flow from the pressurized bottle to the air conditioner/coolant system when actuation lever 6 is depressed. In one instance, when actuation lever 6 is depressed, actuator pin 5 and O-ring 4 move horizontally/backwards thereby opening the flow between the pressurized coolant supply in the refrigerant bottle and the air conditioner/coolant system to be refilled. When actuator pin 5 and O-ring 4 are in the forward, or closed, position, O-ring 4 creates a seal against the back of the splitter assembly 2 thereby preventing flow communications between the refrigerant bottle and the coolant system. Additionally, O-ring 16, placed around a front portion of actuator pin 5, seals pressure within the splitter assembly 2 to prevent any leakage when O-ring 4 is in the backward, or open position. Spring 13 aids the actuator pin 5 to remain in the closed position by creating a tension to return actuator pin 5 and O-ring 4 to the closed position whenever the actuation lever 6 is depressed.

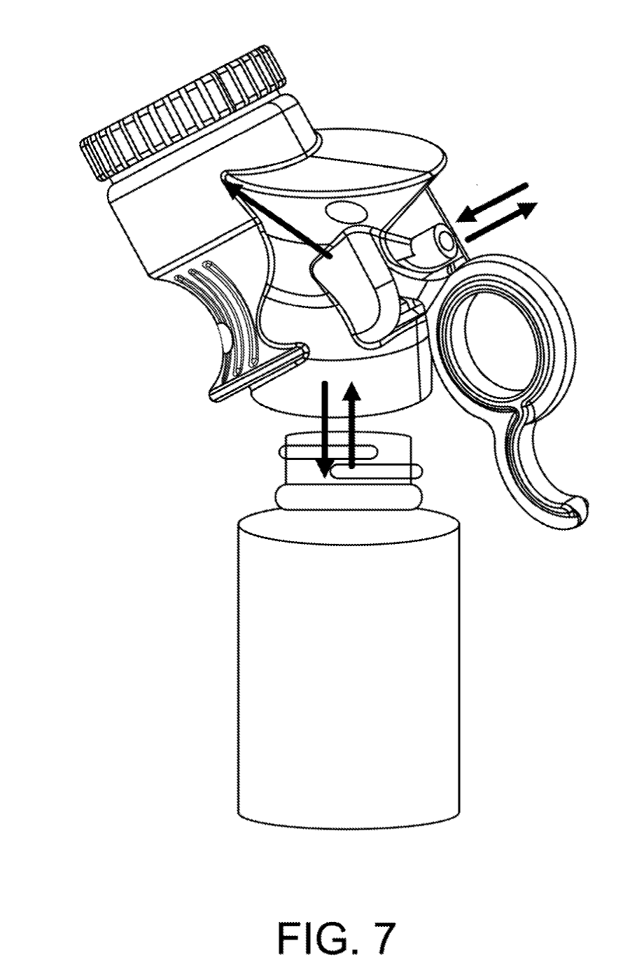

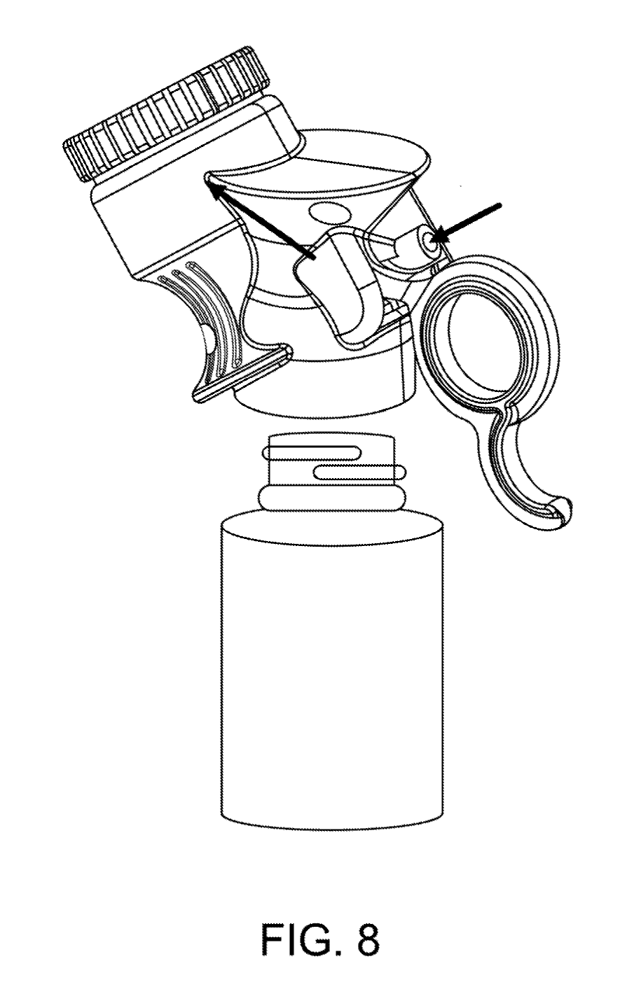

FIGS. 7 and 8 depict the flow communications between a refrigerant bottle and a coolant system (not depicted) connected to port 110 via a hose or any other connecting means when the actuation level 6 is depressed or released, respectively. The arrows depicted in FIG. 7 shows flow communications when actuation lever 6 is depressed thereby opening flow between the coolant system and the refrigerant bottle. In the exemplary embodiment of FIG. 7, flow communications is not prohibited between the measuring gauge 200 and either the refrigerant bottle and the coolant system. As shown by the arrows in FIG. 8, when the actuation lever 6 is released, flow communications to and from the refrigerant bottle is prohibited, thus preserving any remaining refrigerant in the bottle. Additionally, when the actuation lever 6 is released flow communications between the coolant system and measuring gauge 200 allows the measuring gauge 200 to measure the pressure of coolant system. Alternatively, measuring gauge 200 can be adapted to measure any other parameters detectable from the coolant system service port.

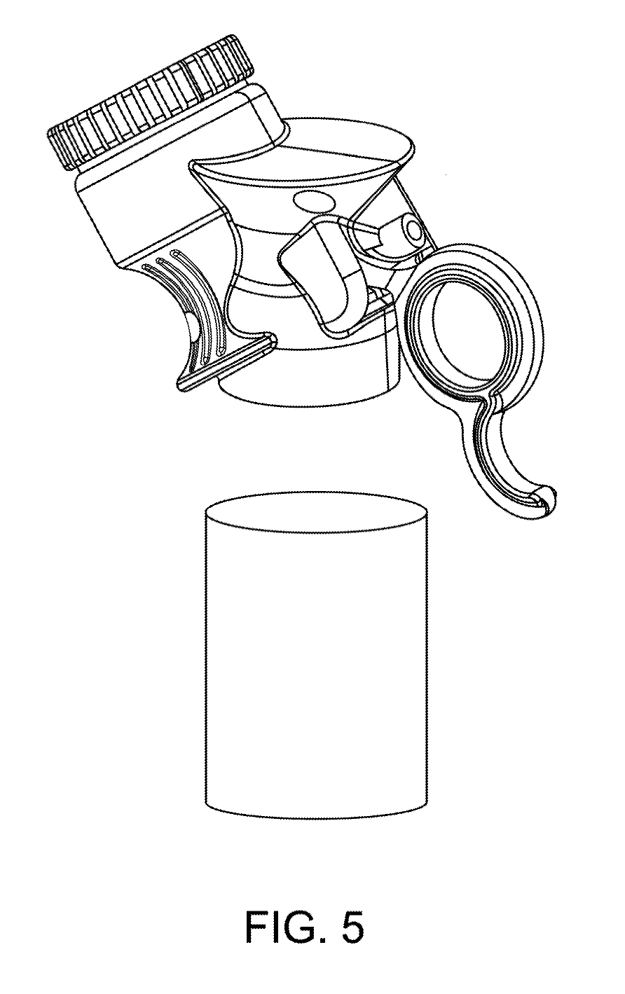

FIG. 5 depicts the use of the bottle actuator assembly 100 with a puncture top bottle. As seen in the components of FIG. 2, the bottle actuator assembly 100 includes a pierce tube 3. When the actuator assembly 100 is connected to a puncture top bottle, pierce tube 3 pierces the puncture top bottle thereby permitting flow of the bottle's 5 contents. Once a puncture top bottle is pierced by pierce tube 3, the bottle actuator assembly 100 must remain attached to the bottle to secure any remaining refrigerant in the bottle.

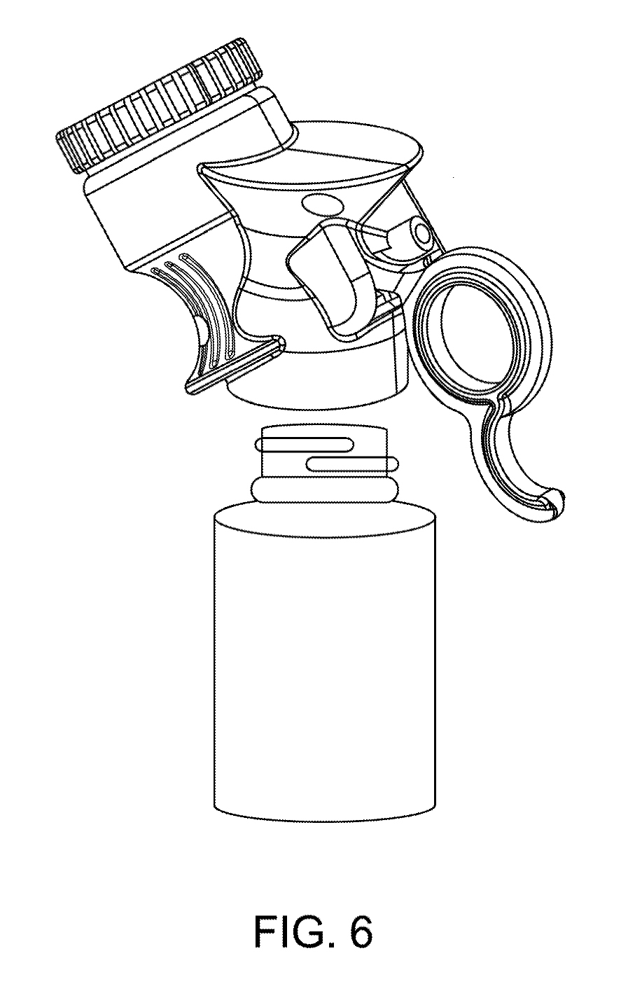

FIG. 6 depicts the use of the bottle actuator assembly 100 with a bottle having an internal valve. Rather than piercing a top to release the bottle's contents, the pierce tube 3 activates the internal valve once the actuator assembly 100 is attached to the bottle thereby permitting flow of the bottle's contents. A bottle with such an internal valve does not require that the bottle actuator assembly 100 remain attached to the bottle after actuation, and the bottle actuator assembly 100 may be removed from the bottle at any time, whether the bottle is full, partially full, or empty as the contents are sealed by the internal valve.

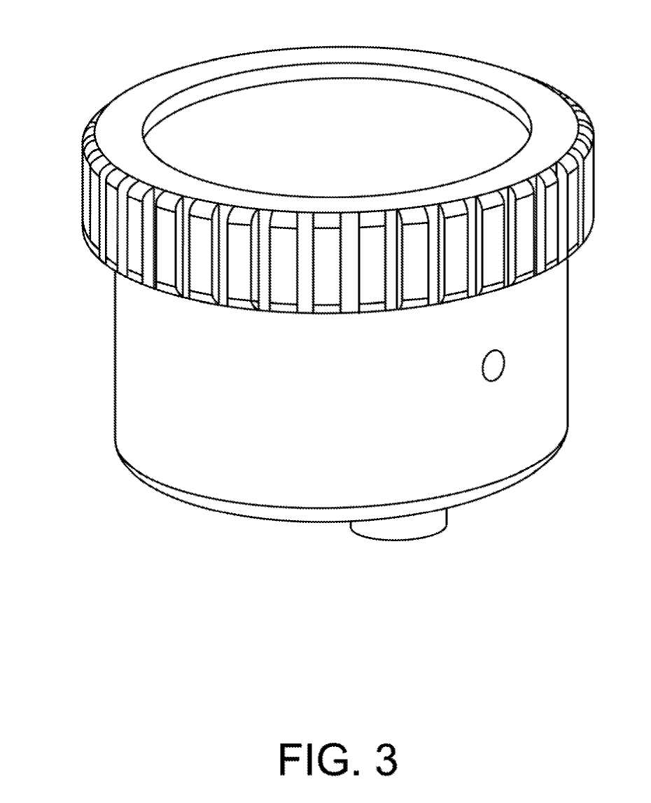

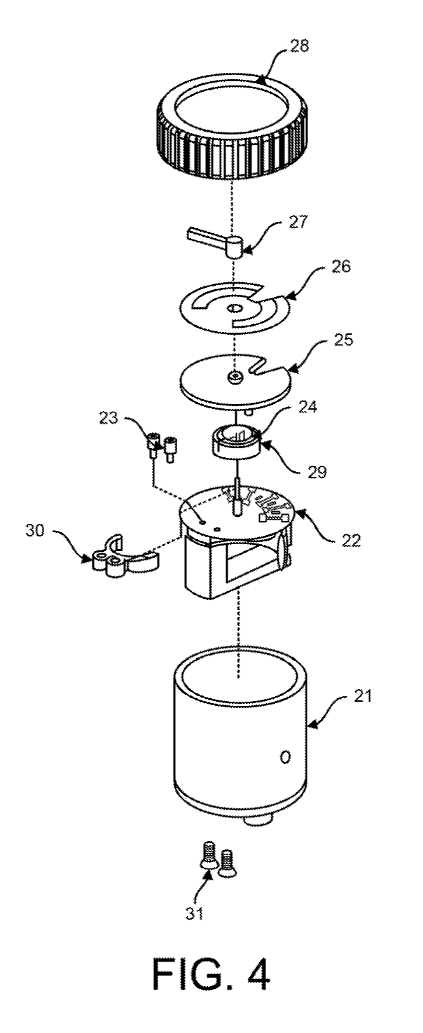

FIGS. 3 and 4 disclose an ambient temperature compensating measuring gauge 200 operable with the bottle actuator assembly 100. Specifically, FIG. 4 shows the individual components of the measuring gauge 200. An exemplary measuring gauge 200 is comprised of a bezel 28, needle 27, temperature mask 26, temperature gate 25, bimetal spring 24, spring cup 29, pressure mechanism 22, cup support 30. The components are secured with rivets 23 and screws 31 before being placed into the gauge shell 21.

The temperature gate 25 along with temperature mask 26, bimetal spring 24, Spring Cup 29 and cup support 30 operate together to adjust the displayed target pressure (PSI) based on ambient temperature. The pressure mechanism 22 positions needle 27 and displays the actual pressure as it moves along the temperature mask 26 to allow the user to fill to the displayed target pressure as adjusted by the temperature mechanism for ambient temperature. As such, an average consumer using measuring gauge 200 can easily understand optimal pressure of the coolant system with respect to the current ambient temperature.

It will be apparent to those skilled in the art that various other modifications and variations can be made in the construction, configuration, and/or operation of the present invention without departing from the scope or spirit of the invention. For example, it is appreciated that the present invention may include a combination of one or more of the bottle actuator assembly 100, the measurement gauge 200, and the coolant supply source provided as a complete product or kit. The depiction of the housing 10 the actuating pin 5, and the splitter assembly 2 are intended to be illustrative only, and not limiting. It is appreciated that an O-ring may be replaced with any other gasket capable of sealing a junction. It is appreciated that the size and shape of the housing 10 may vary markedly without departing from the intended scope of the present invention. These and other modifications to the above-described embodiments of the invention may be made without departing from the intended scope of the invention.

What is claimed is:

1. An apparatus for servicing a coolant system adapted to receive coolant from puncture top bottles or internal valve bottles containing a coolant supply, the apparatus comprising:
a gauge for measuring a parameter of the coolant system;
a housing;
a piercing tube disposed within the housing, adapted to pierce a puncture top bottle and actuate an internal valve; and
means for controlling flow communications between the coolant supply and a coolant system.

2. The apparatus of claim 1, wherein the gauge is disposed within the housing.

3. The apparatus of claim 1, wherein the gauge includes an ambient temperature monitor.

4. A system for servicing a coolant system, the system comprising:
a pressurized bottle having a puncture top or an internal valve;
a bottle actuator assembly in flow communications with the pressurized bottle,
the bottle actuator assembly comprising:
a housing;
a splitter disposed within the housing having at least two ports;
a piercing tube disposed within the splitter, adapted to pierce a puncture top bottle and actuate an internal valve;
a gasket for controlling flow communications to the bottle containing pressurized contents;
an actuation lever for maneuvering an actuator pin; and
means for providing flow communications between the bottle actuator assembly and a service port of the coolant system.

5. The system of claim 4 further comprising, a gauge affixed to the bottle actuator assembly operating to measure a parameter of the coolant system.

6. A bottle actuator assembly for actuating a bottle containing pressurized contents, the bottle actuator assembly comprising:
a gauge;
a housing;
a splitter disposed within the housing having at least three ports;
a piercing tube disposed within the splitter, adapted to pierce a puncture top bottle and actuate an internal valve;
a gasket for preventing flow communications to a pressurized bottle; and
an actuation lever for depressing an actuator pin;

7. The bottle actuator assembly of claim 6, wherein the gauge is disposed within the housing.

8. The bottle actuator assembly of claim 6, wherein the gauge includes an ambient temperature monitor.

9. The bottle actuator assembly of claim 6, wherein the gauge includes a temperature gate.
